(19) United States
(12) Patent Application Publication
(10) Pub. No.: US 2008/0265054 A1
(43) Pub. Date: Oct. 30, 2008

(54) Injector With A Pressure Intensifier That Can Be Switched On

(76) Inventors: Christoph Buehler, Gerlingen (DE); Juergen Frasch, Holzgerlingen (DE); Christoph Butscher, Leonberg (DE); Michael Fleig, Gerlingen (DE); Stephan Wehr, Heiligenstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/910,336

(22) PCT Filed: May 9, 2006
(86) PCT No.: PCT/EP06/62160

§ 371 Date: Oct. 1, 2007

(30) Foreign Application Priority Data
Jun. 29, 2005 (DE) 10 2005 030 220.3

(51) Int. Cl. F02M 47/02

(52) U.S. Cl. 239/88

(57) ABSTRACT

An injector in which it is possible to switch a pressure booster on or off so that it is possible to control not only the injection duration, but also the progression of the injection pressure within a broad range during the injection.

### PRIOR ART

In fuel injection systems equipped with a rail, the rail pressure is generated by a high-pressure pump and stored in a rail. It is not possible to shape the injection curve in such systems.

DE 199 10 970 A1 has disclosed an injector equipped with a pressure booster. This pressure booster serves to increase the fuel pressure supplied from the rail or a high-pressure fuel pump in order to achieve higher injection pressures without having the injection pressure prevail in both the high-pressure fuel pump and the rail

In an injector for a fuel injection system, having a nozzle needle that is guided in a sealed fashion in an injector housing, with one end of the nozzle needle delimiting a control chamber, and having a first control valve, which, in a first switched position, hydraulically disconnects the control chamber from a return and in a second switched position, hydraulically connects the control chamber to the return via an outlet throttle, and having a high-pressure connection that acts on a pressure shoulder of the nozzle needle with pressurized fuel and supplies the control chamber with fuel via an inlet throttle, according to the invention, a pressure booster that can be activated or deactivated is provided between the high-pressure connection on the one hand and the control chamber and pressure shoulder on the other.

### ADVANTAGES OF THE INVENTION

It is thus possible to optionally execute an injection with the pressure prevailing in the rail or to further increase the pressure prevailing in the rail with the aid of the pressure booster. Intermediate forms of these two operating modes are also possible, thus making it possible with the aid of the injector according to the invention to shape the injection curve within a broad range.

Another advantage of the invention is that a leakage in the region of the nozzle needle only occurs at times in which the nozzle needle is open. But at these times, the leakage is not problematic.

Since the pressure booster exerts the maximum possible injection pressure on only very few of the components of the injector, it is possible to select a more reasonably priced construction of the injector. This also extends the service life of components not subjected to the maximum injection pressure.

The pressure booster advantageously has a booster piston that can move in a bore and whose end surfaces each delimit a pressure chamber; a first, larger end surface of the booster piston delimits a first pressure chamber connected to the high-pressure connection, a second, small end surface at the opposite end of the pressure booster piston delimits a second pressure chamber connected to the pressure shoulder and control chamber, and a hydraulic connection equipped with a first check valve is provided between the first pressure chamber and the second pressure chamber.

In this embodiment of the pressure booster, it is possible for fuel to flow from the first pressure chamber into the second pressure chamber, whereas the check valve prevents fuel from flowing out of the second pressure chamber and back into the first pressure chamber. This makes it easily possible to act on the control chamber and the pressure shoulder with fuel that is only at the pressure prevailing in the rail.

It is particularly advantageous if the hydraulic connection is embodied in the form of a longitudinal bore in the booster piston. The essential reason for this is the simple manufacture and the fact that no additional lines need to be sealed.

In a particularly compact design, the first check valve is also situated in the booster piston. It is thus possible, once it has been preinstalled in the booster piston, to test the first check valve outside of the actual injector and thus to set it to the desired opening pressure.

In another advantageous embodiment of the pressure booster according to the invention, a cross-sectional change in the booster piston and a shoulder in a housing of the pressure booster delimit a relief chamber and the relief chamber can be optionally connected either to the return or to the high-pressure connection. When the relief chamber is hydraulically connected to the return, the booster piston can move as soon as the first pressure chamber is acted on with pressure from the rail and can thus execute a pressure boosting.

As soon as the relief chamber is hydraulically connected to the high-pressure connection, the forces acting on the booster piston from the relief chamber and the first pressure chamber equalize to such an extent that the pressure booster is not active.

The switching on and off of the pressure booster is advantageously carried out with the aid of a second control valve, which optionally connects the relief chamber to either the return or the high-pressure connection.

The pressure booster is advantageously provided with a return spring that exerts a return force on the booster piston in the direction toward the first pressure chamber. As a result, after the injection is executed, the booster piston returns to its original position and fuel displaced from the second pressure chamber is replenished by the return motion of the booster piston.

The return spring can advantageously be situated in either the first pressure chamber or the relief chamber.

With the aid of the method according to the invention, it is possible to shape the curve of an injection within a broad range, thus enabling further improvements with regard to fuel consumption, emissions behavior, and noise generation.

Other advantages and advantageous embodiments of the invention can be inferred from the drawings below, their description, and the claims. All of the defining characteristics shown in the drawings or disclosed in their description and the claims can be essential to the invention both individually and in any combination with one another.

### DRAWINGS

FIG. 1 is a schematic depiction of a fuel injection system equipped with an injector according to the invention and

FIG. 2 shows the chronological progression of the injection pressure.

### DESCRIPTION OF THE EXEMPLARY EMBODIMENTS

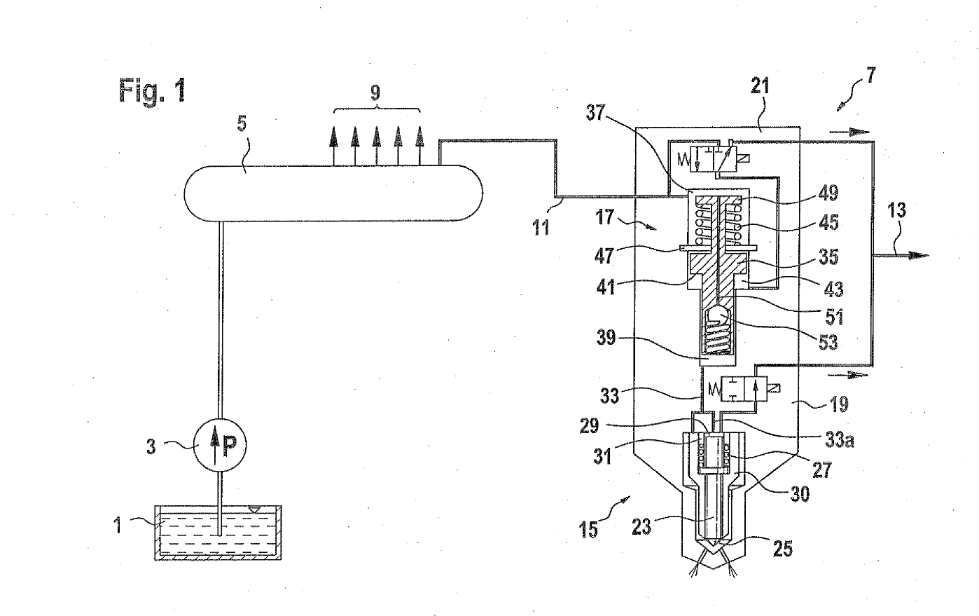

FIG. 1 is a very schematic depiction of a fuel injection system comprised of a tank 1, a high-pressure fuel pump 3, a rail 5, and an injector 7. Only one injector 7 is shown in FIG. 1.

For the sake of clarity, the other injectors are only indicated by arrows 9.

A high-pressure connection 11 connects the injector 7 to the rail 5. A return 13 of the injector 7 conveys the control quantities and leakage quantities back to the tank 1.

The injector 7 according to the invention can be divided into three subassemblies. The first subassembly includes an injection module 15, the second subassembly includes a pressure booster 17, and the third subassembly is composed of a first control valve 19 and a control valve 21.

The injection module 15 has the same design as the one in conventional injectors. A nozzle needle 23 with a sealing cone 25 at its one end is guided in a housing.

A closing spring 27 presses the sealing cone 25 against a sealing seat (unnumbered) of the housing. In this position, the nozzle needle 23 in the injector 7 is closed and no injection occurs.

At the end oriented away from the sealing cone 25 the nozzle needle 23 delimits a control chamber 29. In the radial direction, the control chamber 29 is delimited by a sleeve 31 against which the closing spring 25 rests. The sleeve 31 is thus pressed in a sealed fashion against a shoulder in the housing of the injector 7. Since the diameter of the nozzle needle 23 in the region of the control chamber 29 is greater than the diameter of the sealing seat between the sealing cone 25 and the housing, a pressure shoulder is formed on the nozzle needle 23, which exerts a hydraulic force on the nozzle needle 23 in opposition to the force exerted by the closing spring 27.

A high-pressure conduit 29 supplies pressurized fuel both to a pressure chamber 30 that encompasses the nozzle needle 23 and to the control chamber 29. An inlet throttle, not shown, is provided in the section 33a of the high-pressure conduit.

The control chamber 29 is connected via an outlet throttle (not shown) and the first control valve 19 to the return 13 when the first control valve is open. This switched position of the first control valve 19 is shown in FIG. 1.

As soon as this hydraulic connection between the control chamber 29 and the return 13 is open, the pressure in the control chamber 29 drops so that the hydraulic forces acting on the nozzle needle 23 in the pressure chamber 30 exceed the closing force of the closing spring 27 and the compressive force exerted on the nozzle needle 23 by the fuel in the control chamber 29, then the nozzle needle 23 lifts away from the housing of the injector 7. The lifting of the nozzle needle 23 starts the injection.

As soon as the first control valve 19 is closed, the same pressure builds up in the control chamber 29 as in the control chamber 30 and as a result, the nozzle needle 23 closes again.

The pressure booster 17 is situated between the high-pressure connection 11 and the high-pressure conduit 33.

The pressure booster 17 has a booster piston 35. A first pressure chamber 37 of the pressure booster 17 is connected directly to the high-pressure connection 11, while a second pressure chamber 39 is hydraulically connected to the high-pressure conduit 33.

In the exemplary embodiment shown in FIG. 1, the end surfaces of the booster piston 35 are not embodied in the form of flat surfaces. But this changes nothing with regard to the fact that when the first pressure chamber 37 is acted on with the pressure from the rail 5, the booster piston 35 is pressed downward and, due to the smaller diameter of the second pressure chamber 37, a correspondingly higher pressure is generated there. This only applies, however, when a relief chamber 43 situated between a shoulder in the housing of the injector and a cross-sectional change 41 in the booster piston 35 is unpressurized.

In the switched position of the second control valve 31 shown in FIG. 1, the relief chamber 43 is connected to the return 13 so that no pressure can build up in the relief chamber 43.

This means that in the switched position of the first control valve 19 and second control valve 31 shown in FIG. 1, the pressure booster is active and as a result, the injection occurs at a pressure that is higher than the fuel pressure prevailing in the rail 5.

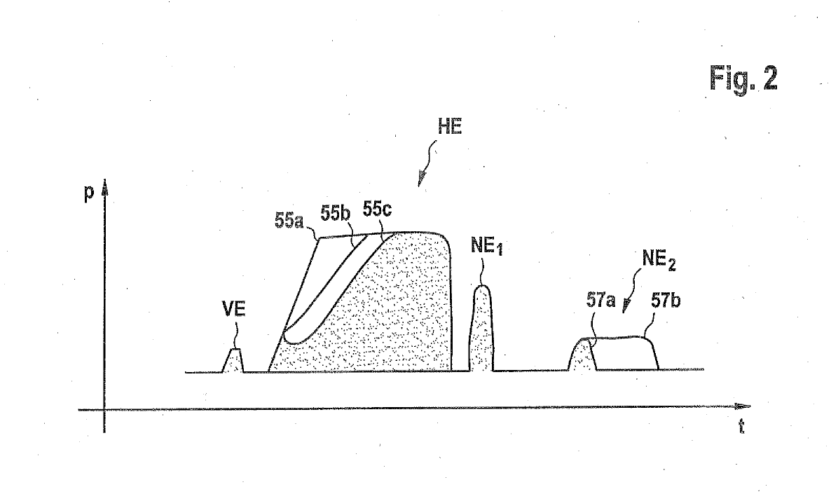

The pressure booster 17 can be deactivated by bringing the second control valve 21 into the second switched position that is not shown in FIG. 2. In this second switched position, the relief chamber 43 is acted on with the pressure prevailing in the rail 5 so that a force is exerted on the shoulder 41 of the booster piston 35, which presses the booster piston 35 upward in FIG. 1. This return movement of the booster piston 35 is also assisted by a return spring 45, which, in the exemplary embodiment of the pressure booster 17 shown in FIG. 1, is situated inside the first pressure chamber 37.

To that end, a stroke stop 47 and an overhang 49 are provided on the booster piston 35. The return spring 45 is clamped between them.

When the pressure booster 17 is deactivated by bringing the second control valve 21 into the second switched position not shown in FIG. 1, then by means of a longitudinal bore 51 and a check valve 53 that are both situated in the booster piston 35, the fuel can travel from the rail 5 to the control chamber 29 and pressure chamber 30 via the high-pressure connection 11, the longitudinal bore 51, the check valve 53, and the high-pressure conduit 33.

This means that when the pressure booster 17 is deactivated, the injection module 15 functions like a conventional injector without a pressure booster.

In other words: by switching on the pressure booster 17 with the aid of the second control valve 21, an injection pressure can be achieved that is higher than the pressure prevailing in the rail 5, whereas when the pressure booster 17 is switched off, the injection occurs at the pressure prevailing in the rail 5.

Because combinations of these operating modes can also be achieved through suitable triggering of the control valves 19 and 21, there is a considerable degree of freedom in the shaping of an injection curve.

In the exemplary embodiment shown in FIG. 1, leakage along the sleeve 31 prestressed by means of a closing spring 27 occurs only when the first control valve 19 is open. By contrast, no leakage or only a small amount of leakage occurs when the injection valve is closed. For example, a leakage of this kind occurs at the guiding diameter of the valve needle of a solenoid valve.

FIG. 2 shows the chronological progression of the injection pressure in the form of a graph.

In the example of a fuel injection shown in FIG. 2, a preinjection VE is executed at a low injection pressure. This is followed by main injection HE that can occur, for example, in accordance with the lines 55a, 55b, or 55c. These three injection curves of the main injection HE that are shown by way of example demonstrate very clearly that it is possible to shape an injection curve within a broad range.

After the actual main injection HE, a first secondary injection NE₁ occurs in which the pressure is less than during the main injection, but greater than during the preinjection VE.

This is followed by an additional secondary injection NE₂ that can, for example, have a chronological progression in accordance with the lines 57a or 57b. With this second secondary injection NE₂ as well, which occurs at an injection pressure similar to that of the preinjection VE, the injection duration can be varied within a broad range through a suitable triggering of the first control valve 19.

In the injector according to the invention, the two control valves 19 and 21 can control the pressure boosting and duration as well as the onset and end of an injection independently of one another.

When the pressure boosting and the injection are activated chronologically offset from each other, the injection curve can be variably shaped within a very broad range. For example, it is possible to achieve a ramp-shaped injection curve, a rectangular injection curve, or a boot-shaped injection curve.

All types of valves known from the prior art, whether of the slide valve variety and/or of the slot-control valve variety, can conceivably be used for the control valves 19 and 21. It is also possible for the valves to be triggered by means of electromagnets, piezoelectric actuators, or other actuators.

1-14. (canceled)

15. An injector for a fuel injection system of an internal combustion engine, the injector comprising a nozzle needle that is guided in a sealed fashion in an injector housing, with one end of the nozzle needle delimiting a control chamber, a first control valve, which, in a first switched position, hydraulically disconnects the control chamber from a return and in a second switched position, hydraulically connects the control chamber to the return via an outlet throttle, a high-pressure connection that acts on a pressure chamber with pressurized fuel and supplies the control chamber with fuel via an inlet throttle, in which a pressure booster is provided between the high-pressure connection on the one hand and the control chamber and pressure chamber on the other, and means for selectively activating or deactivating the pressure booster.

16. An injector for a fuel injection system of an internal combustion engine as defined in claim 15, wherein the pressure booster comprises a booster piston that is able to move in a bore, the booster piston having a first, larger end surface and a second, smaller end surface on its opposite end, the first and second end surfaces each delimiting a pressure chamber, the first, larger end surface delimiting a first pressure chamber connected to the high-pressure connection and the second, smaller end surface delimiting a second pressure chamber connected to the pressure chamber and control chamber, and a hydraulic connection equipped with a first check valve between the first pressure chamber and the second pressure chamber.

17. The injector according to claim 16, wherein the hydraulic connection is embodied in the form of a longitudinal bore in the booster piston.

18. The injector according to claim 16, wherein the check valve is situated in the booster piston.

19. The injector according to claim 17, wherein the check valve is situated in the booster piston.

20. The injector according to claim 16, further comprising a relief chamber delimited by a cross-sectional change of the booster piston and a shoulder in a housing of the pressure booster, and means operably to optionally connect the relief chamber to either the return or the high-pressure connection.

21. The injector according to claim 17, further comprising a relief chamber delimited by a cross-sectional change of the booster piston and a shoulder in a housing of the pressure booster, and means operably to optionally connect the relief chamber to either the return or the high-pressure connection.

22. The injector according to claim 18, further comprising a relief chamber delimited by a cross-sectional change of the booster piston and a shoulder in a housing of the pressure booster, and means operably to optionally connect the relief chamber to either the return or the high-pressure connection.

23. The injector according to claim 20, further comprising a second control valve operable to connect the relief chamber to either the return or the high-pressure connection.

24. The injector according to claim 16, wherein the pressure booster comprises a return spring acting on the booster piston with a return force acting in the direction of the first pressure chamber.

25. The injector according to claim 17, wherein the pressure booster comprises a return spring acting on the booster piston with a return force acting in the direction of the first pressure chamber.

26. The injector according to claim 20, wherein the pressure booster comprises a return spring acting on the booster piston with a return force acting in the direction of the first pressure chamber.

27. The injector according to claim 23, wherein the pressure booster comprises a return spring acting on the booster piston with a return force acting in the direction of the first pressure chamber.

28. The injector according to claim 24, wherein the return spring is situated in the first pressure chamber.

29. The injector according to claim 16, wherein the booster piston is composed of two parts.

30. A method for injecting fuel into the combustion chamber of an internal combustion engine by means of an injector according to claim 15, the method comprising the steps of,
opening of the first control valve at the beginning of an injection,
activating the pressure booster when the injection pressure should be higher than the pressure in the high-pressure connection, and
closing of the first control valve at the end of an injection.

31. The method according to claim 30, wherein the pressure booster is activated at the same time as or before the opening of the first control valve.

32. The method according to claim 30, wherein the pressure booster is activated after the opening of the first control valve.

33. The method according to claim 30, wherein the pressure booster is deactivated before the closing of the first control valve.

34. The method according to claim 32, wherein the pressure booster is deactivated at the same time as or after the closing of the first control valve.
